(19) United States
(12) Patent Application Publication
(10) Pub. No.: US 2026/0084299 A1
(43) Pub. Date: Mar. 26, 2026

(54) Recognizing and Dealing with Unknown Situations in an Industrial Environment

(71) Applicant: Siemens Aktiengesellschaft, Muenchen (DE)

(72) Inventors: Michel TOKIC, München (DE); Anja VON BEUNINGEN, München (DE); Matthias TEUCHERT, Erlangen (DE); Ingo GEIER, Erlangen (DE)

(21) Appl. No.: 19/338,298

(22) Filed: Sep. 24, 2025

(30) Foreign Application Priority Data
Sep. 25, 2024 (EP) 24202499

(51) Int. Cl. B25J 9/16; G06N 3/045

(52) U.S. Cl. CPC B25J 9/163; G06N 3/045

(57) ABSTRACT

A computer-implemented method, a computer-implemented device, a system and a computer program product for environment-specific determination of at least one action option of a movable robot part includes acquiring information associated with an environment of the movable robot part, converting the acquired information into a description of the environment, providing the description to a first trained neural network that determines the at least one action option based on the description provided, determining whether the provided at least one action option is defined to an extent sufficient to be implemented by the movable robot part, initiating a dialog with an auxiliary entity different from the robot part to acquire further context information upon determining that the provided at least one action option is not sufficiently defined, and providing the at least one action option to a controller of the movable robot part.

### BACKGROUND OF THE INVENTION

### 1. Field of the Invention

The present invention relates to a method and device for enabling the safe interaction of robots with an object in the presence of existing uncertainties regarding an action option to be performed.

### 2. Description of the Related Art

Robots are used in modern industrial installations for a variety of tasks to be performed. The use of robots comprises, for example, performing routine tasks or else performing tasks that should be regarded as hazardous to human health. Robots may, in this case, be operated manually or perform a predefined sequence of actions, where their degree of autonomy may vary.

One problem that commonly occurs in this connection is that robots are usually only able to deal with objects that they already know, and are usually able to perform only predefined actions with the objects in question.

Adapting existing robots to new environments with changing requirements (for example, changed required manipulation steps), unknown tasks and/or manipulation of new objects is usually a complex process. Robots are usually not able to make their own decisions and, in this regard, need to be coordinated with a human operator and/or are only able to act within defined limits.

In other cases, it may be the case (or be necessary) that a human worker has to perform the majority of a task to be performed, and robots contribute to solving the task in question (such as robot-based loosening of screws and/or sorting of objects by known properties) only on an assistive basis (as part of predefined action steps).

It may be necessary for robots to autonomously recognize an object (kind, type, and/or model) before it is possible to derive an action option for the robot based thereon. This may comprise, for example, a robot recognizing whether an object is a cell phone or a calculator that is to be disassembled and recycled. Based thereon, a robot could derive the location, on the object in question, of each of the screws that need to be loosened in order to disassemble the object. The object recognition may thus be taken as a basis for performing various action options that may enable optimum disassembly of the object in question.

This may be limiting, for example, if a robot is to be used for battery recycling purposes. Batteries are usually manufactured in different sizes and models and by different manufacturers, meaning that there may be a wide range of different battery models that should ideally be able to be handled by a robot in order to enable a robot-based battery recycling process. Different battery manufacturers have different ways of assembling a battery. Consequently, this results in a variety of possible and unknown steps, which a robot must know for a recycling process for such a battery. Even though there may be a certain amount of overlap or some similarities in terms of the recycling process for different battery types, it may still be necessary to equip a robot with an appropriate variety of action options in order to be able to ensure appropriate battery recycling.

It may be particularly important to program a robot (for example, via an artificial intelligence) such that it is able to deal with varying circumstances, in order thus, for example, to be able to safely disassemble or recycle a battery (possibly of a hitherto unknown type). The underlying problem often arises, in particular when dealing with uncertainties in the sequence of actions of a corresponding robot, ideally without having to involve a human operator.

While this is possible in the case of very simple applications, robots still fail when faced with more complex problems, meaning that a human operator must still perform certain manufacturing steps or manipulations on an object so that the robot can then perform further manipulation steps that build thereon. In alternative cases, it may also be the case that a human operator themselves has to complete a task associated with manipulation of an object. In order to be able to ensure, in such a case, that the robot can handle the situation in question in the event of the same problem possibly reoccurring, the robot usually has to be configured appropriately (and/or training is required). This configuration must then undergo extensive testing (both in test environments and in new environments that may possibly occur). It may then be necessary to turn off the robot and provide it with a corresponding update. However, this procedure may be personnel-intensive and time-consuming, and entails high costs for configuring the robot.

If there are disassembly plans for the object to be disassembled (for example, in the case of a battery), these may also be taken into account at disassembly. However, not all objects have such disassembly plans, and so these are able to be used only in isolated cases.

In order to provide a wider range of disassembly plans, political efforts are being made to obligate battery manufacturers to provide disassembly plans (in the sense of battery passports). This might allow for disassembly of batteries sold in the future, but does not act retrospectively on batteries that have already been sold, and therefore still does not provide any improvement on the current situation of a lack of disassembly plans for batteries that are already in circulation. Furthermore, devices that contain the batteries are not covered by any obligation to provide disassembly plans, even though these will also have to be disassembled and recycled in the future.

The approaches used at present with regard to the robot-controlled manipulation of objects therefore cannot be ensured in all (desired) application scenarios.

There is therefore a need to further improve control of robots, in particular in the context of unknown environments.

### SUMMARY OF THE INVENTION

In view of the foregoing, it is an object of the present invention is to enable the safe interaction of robots with an object in the presence of existing uncertainties regarding an action option to be performed.

This and other objects are achieved in accordance with the invention by a computer-implemented method for environment-specific determination of at least one action option of a movable robot part. The computer-implemented method comprises acquiring information associated with an environment of the movable robot part and converting the acquired information into a description of the environment. The computer-implemented method furthermore comprises providing the description to a first trained neural network, where the first trained neural network determines the at least one action option based on the provided description, and determines whether the provided at least one action option is defined to an extent sufficient to be performed by the movable robot part. The computer-implemented method furthermore comprises initiating a dialog, with an auxiliary entity different from the robot part, in order to acquire further context information if it has been determined that the provided at least one action option is not sufficiently defined, and providing the at least one action option to a controller of the movable robot part.

The robot part may be, for example, a robot arm that is able to move, for example, along at least one degree of freedom (for example, a rotational and/or translational degree of freedom). As an alternative, the movable robot part may be, for example, a tool part of a robot that is able to perform a rotational and/or translational movement. In such a case, the movable part may be provided, for example, with a tool that may enable it to loosen or tighten a screw of an object to be manipulated when the movable robot part rotates. In other cases, the tool may be provided such that a sawing function is able to be performed when the movable robot part is moved back and forth, for example, when the tool is provided as a saw (element).

The at least one action option of the movable robot part may be understood to mean a movement of the movable robot part. This movement may be, for example, a rotational and/or a translational movement.

The acquired information may be acquired by one or more sensors. In addition or as an alternative, the acquired information may be loaded from a server (for example, from a database).

In some cases, the description may be provided as a textual description. The textual description may be understood to mean a description of the acquired information in text form. If the acquired information comprises, for example, one or more images, then the textual description may be provided such that it describes the content of the image in text form. This may indicate, for example, that the image depicts a cell phone, a calculator or another device.

Determining whether the at least one action option is sufficiently defined may comprise determining whether sufficient information is available to the first trained neural network to determine, based on the information, the at least one action option such that a desired manipulation of an object is able to be performed successfully or for the intended purpose. Determining whether the at least one action option is sufficiently defined may comprise determining a parameter indicative of sufficient definition of the at least one action option. If the parameter thus determined exceeds a predefined threshold value, then the at least one action option may be considered to be sufficiently defined.

It may be determined that the at least one action option is not sufficiently defined, for example, if it is not possible to clearly establish, based on the acquired information, which object is to be manipulated by the movable robot part. Based thereon, the at least one action option may be considered to be not sufficiently defined if the first trained neural network cannot be supplied with sufficient information about which object (for example, type, model, and/or size) and/or which part of the object (for example, which screw (for example, size, and/or type)) is to be manipulated.

In some cases, the dialog with the auxiliary entity may occur by issuing at least one question to the auxiliary entity. The question may be issued to the auxiliary entity, for example, via a display (for example, a display screen, and/or monitor) and/or a loudspeaker. As an alternative, it may also be possible to initiate the dialog via a data connection (for example, via an Internet and/or an intranet). In preferred embodiments, the dialog may be initiated without a calibration dataset. In some cases, an answer to the at least one question may be acquired. The acquired answer may be understood to be a basis for determining the at least one action option (and/or a further at least one action option). The answer may be received, for example, via an auxiliary entity connected to a neural network (for example the first neural network and/or the second neural network and/or a third neural network). The neural network in question may comprise for example speech recognition (for example, a large language model (LLM)).

This may enable improved handling of an unknown situation from the point of view of a movable robot part. This may be made possible by virtue of a human operator not having to intervene in a manipulation process performed by the movable robot part in the event of a situation unknown to the movable robot part occurring (for example, if the at least one action option is considered to be not sufficiently defined), but rather, in such a case, a dialog with an auxiliary entity may be initiated, based on which further information may be requested in order to be able to perform and complete a desired manipulation of an object even in the presence of an unknown situation.

In accordance with one embodiment, the auxiliary entity may be a human operator of the movable robot part; a human operator who is able to connect remotely to the movable robot part; a human operator who is able to connect remotely to an auxiliary robot in the vicinity of the movable robot part; and/or a second trained neural network that has been trained on a larger training database than the first trained neural network.

A human operator may be physically present, i.e., a human operator may be located in close proximity to the movable robot part.

A remote connection between the movable robot part may be made in wireless and/or wired fashion, for example. The remote connection may be established via the Internet and/or an intranet.

The auxiliary robot may be located in close proximity to the movable robot part. The auxiliary robot may be equipped with at least one sensor, which may be configured to acquire further information associated with the environment of the movable robot part.

The second trained neural network may have been trained with a higher number of training data compared to the first neural network, and may thus ultimately fall back on a larger training database than the first trained neural network. This may make it possible, using the second neural network, to be able to provide an improved database, which may serve as an auxiliary entity, as a result of which the at least one action option is able to be provided in improved fashion.

This may make it possible, using the auxiliary entity, to acquire information that was hitherto lacking for a sufficient definition of the at least one action option, without having to cancel a manipulation of an object to be performed by the movable robot part and/or having to have this performed by a human operator. The determination of the at least one action option and, ultimately, also the manipulation process to be performed via the movable robot part may thereby be improved.

In accordance with a further embodiment, the at least one action option of the movable robot part may be associated with a disassembly plan of an electrical device and/or battery.

In some cases, the object may be an electrical device and/or a battery.

A disassembly plan may serve as a guide that shows individual steps that are able to be performed in a sequence in order to disassemble the electrical device and/or the battery, i.e., break it down into its individual components. This may aid recycling of the electrical device and/or the battery. This makes it possible to enable efficient and targeted disassembly of the electrical device and/or the battery.

In accordance with a further embodiment, providing the description may comprise taking into account a provided disassembly plan for the electrical device and/or the battery.

In some cases, the provided disassembly plan may be converted into a description. The disassembly process to be performed may thereby be described in text form. The description thus obtained of the disassembly plan may be mixed with the description of the acquired information and/or appended or concatenated to the description of the acquired information.

The at least one action option may thereby be determined as far as possible analogously to the provided disassembly plan. Overall, this may enable an improved disassembly process for the movable robot part.

In accordance with a further embodiment, the computer-implemented method may be performed for each step of a disassembly step associated with the disassembly plan.

In some cases, the at least one action option may replicate a disassembly step according to the disassembly plan.

It is thereby possible to determine an optimized at least one action option for the movable robot part for each disassembly step. This may optimize the disassembly process.

In accordance with a further embodiment, the first trained neural network and/or the second trained neural network may comprise a large language model (LLM), preferably a generative pre-trained transformer (GPT). This may contribute to optimum initiation of the dialog with the auxiliary entity.

The first trained neural network and/or the second trained neural network may consist just of the LLM (preferably the GPT) or comprise same, in addition to other components (for example, a further third neural network). This may enable efficient processing of textual information.

In accordance with yet a further embodiment, acquiring the information may comprise acquiring an object type of an object that is to be manipulated by the movable robot part and/or acquiring a manufacturer of the object and/or a pose of the object in the environment.

The object type may be understood here to mean the type of object that is present and is to be manipulated by the movable robot part. A type may be understood to mean, for example, the object category, such as whether the object is a cell phone, a calculator, or a battery.

In some cases, the acquiring may be understood to mean acquiring a size of the object to be manipulated.

A pose of the object in the environment may be understood to mean an orientation of the object relative to a reference system (for example, a reference axis). Acquiring the information may comprise determining the spatial angles about which the object is rotated (and/or shifted) relative to the reference system (or reference axis).

Acquiring the object type makes it possible to establish which object is to be manipulated by the movable robot part. The acquired object type may also be used to derive the dimensions (for example, metric and/or imperial dimensions) of the object and which parts (for example, screws, and/or adhesive points) should be expected at which point of the object. Determining the pose of the object may comprise determining an orientation of the object relative to, for example, a tool attached to the movable robot part.

In accordance with a still further embodiment, the computer-implemented method, when acquiring the information comprises acquiring an object type of an object, may furthermore comprise determining a first uncertainty indicative of an uncertainty with which an acquired object has been assigned to an object type, and where, if the first determined uncertainty exceeds a first threshold value, then the movable robot part performs the determined at least one action option. If the first determined uncertainty falls below the first threshold value and exceeds a second threshold value, then a human operator may be asked to confirm that the determined at least one action option is to be carried out, which may be followed by performing the at least one action option based on the confirmation. As an alternative, if the determined first uncertainty is less than the second threshold value, then at least one predefined action option may be provided to a human operator, confirmation may be acquired from the human operator that the provided predefined action option is to be performed, and the predefined action option may be performed based on the acquired confirmation.

The first uncertainty may be understood here to mean a (numerical) parameter that indicates the probability of an assignment of the object to an object type being incorrect, i.e., the probability of the assigned object actually needing to be assigned to an object type different from the one to which it has actually been assigned. The numerical parameter may move in a range from 0%-100%, where a probability of 0% indicates that the assignment should be considered to be untrusted or uncertain, and wherein a probability of 100% indicates that the assignment should be considered to be very trusted.

In some cases, acquiring the object type may comprise classifying the object type based on the acquired information. Classification may be understood here to mean a method in which a computer-based system automatically puts objects, data or situations into predefined categories or classes based on machine learning algorithms and models. This method may be based on analysing features or properties of the elements to be classified and recognizing patterns in the input data. The system is typically trained here with a set of pre-classified examples in order, from these learning data, to derive rules or decision criteria that allow it to assign new, unknown instances to the corresponding classes. The aim is to achieve the most precise and reliable assignment possible that makes it possible to automate complex decision-making and recognition tasks and generalize them to new situations.

The object type may be acquired based on a classification, as described herein.

The determined at least one action option may thereby be implemented on a context-specific basis.

In accordance with a further embodiment, determining the at least one action option may furthermore comprise determining a second uncertainty associated with determining the at least one action option.

The second uncertainty may be understood here to mean a (numerical) parameter that indicates whether the determined at least one action option may be considered to be an optimum action option. The numerical parameter may in this case move in a range from 0%-100%, where a probability of 0% indicates that the assignment should be considered to be non-optimum, and where a probability of 100% indicates that the assignment should be considered to be optimum.

The second uncertainty may be caused by the fact that the first trained neural network, in the case of repeated provision of the description to the first trained neural network, may provide a different at least one action option. In some cases, the first trained neural network cannot be queried directly, rather only via an application programming interface (API). If, on the other hand, the first neural network can be queried directly, then the first neural network may provide an output that indicates a discrete probability distribution over the activation strength of all tokens (i.e., letters) in the underlying alphabet. In some cases, the uncertainty of the first neural network may be determined based thereon. If an equally distributed activation strength results over different tokens, then this may be considered to be an indication that the first neural network is uncertain regarding an assignment of the output of the first neural network to a relevant input. This may contribute to improved meaningfulness of the determined at least one action option.

In accordance with a further embodiment, the provision of the description and the determination of the at least one action option may be repeated N times, with N≥1, where the at least one action option may be provided based on the N-times repetition of the provision of the description and determination of the at least one action option.

Repeatedly performing the provision N times may comprise providing the description to the first trained neural network N times, so that at least one action option is accordingly provided N times.

It is thereby possible to efficiently provide a statistical evaluation of the determination of the at least one action option and thus improve the reliability of the determination of at least one action option that should be considered to be optimum.

In accordance with an even further embodiment, the provision of the at least one action option may furthermore comprise determining a frequency distribution of the N determined action options, determining an action option of the N determined action options that has been determined with a maximum frequency, and providing the determined at least one action option.

The frequency distribution may be provided as a histogram, where a frequency of a determined at least one action option may be plotted against the respective determined at least one action option.

The provision of the at least one action option may comprise providing the at least one action option that has the highest frequency in accordance with the determined frequency distribution.

The reliability of the final provision of the at least one action option may thereby be improved.

The objects and advantages are also achieved in accordance with the invention by a computer program product comprising instructions which, when the program is executed by a computer, cause the computer to perform the method in accordance with the disclosed embodiments as described herein.

A computer program product, such as a computer program means, may be provided or delivered, for example, as a storage medium such as a memory card, a USB stick, a CD-ROM, a DVD, or else in the form of a file downloadable from a server in a network. This may occur, for example, in a wireless communication network by transmitting an appropriate file comprising the computer program product or the computer program means.

The objects and advantages are further achieved in accordance with the invention by a computer-implemented device for environment-specific determination of at least one action option of a movable robot part. The computer-implemented device comprises an acquisition unit for acquiring information associated with an environment of the movable robot part, a conversion unit for converting the acquired information into a description of the environment, a first provision unit for providing the textual description to a first trained neural network, and a first determination unit for determining, via the first trained neural network, the at least one action option based on the provided description. The computer-implemented device furthermore comprises a second determination unit for determining whether the provided at least one action option is defined to an extent sufficient to be performed by the movable robot part, an initiation unit for initiating a dialog with an auxiliary entity different from the robot part in order to acquire further context information upon determining that the provided at least one action option is not sufficiently defined, and a second provision unit for providing the at least one action option to a controller of the movable robot part.

The respective unit, for example the acquisition unit, the conversion unit, the first determination unit, the second determination unit, the first provision unit, the initiation unit and/or the second provision unit, may be implemented in the form of hardware and/or also in the form of software. In the case of an implementation in the form of hardware, the respective unit may be in the form of a device or part of a device, for example, in the form of a computer or a microprocessor or a control computer of a vehicle. In the case of an implementation in the form of software, the respective unit may be in the form of a computer program product, a function, a routine, part of a program code or an executable object.

The environment of the movable robot part may be understood to mean a factory hall in which the movable robot part is located. In addition or as an alternative, the environment may comprise an object that is to be manipulated by way of the movable robot part.

In accordance with a first embodiment, the computer-implemented device may furthermore comprise a first execution unit for performing the computer-implemented method in accordance with the disclosed embodiments and/or a second execution unit for executing the computer program product in accordance with the disclosed embodiments.

The first execution unit and/or the second execution unit may be provided for example as a computer, a processor, a field-programmable gate array (FPGA) or a combination thereof.

The objects and advantages are also achieved in accordance with the invention by a system for environment-specific determination of at least one action option of a movable robot part. The system comprises the computer-implemented device as described herein and the computer program product as described herein.

Even though the embodiments described herein are shown in isolation, they may also be combined with one another as desired.

The embodiments and features described for the proposed device apply accordingly to the proposed method, and vice versa.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DECRIPTION OF THE DRAWINGS

Further advantageous configurations and aspects of the invention are the subject of the invention that are described below, where the invention is explained in more detail below based on preferred embodiments with reference to the attached figures, in which:

FIG. 1 shows a schematic flowchart of a method for the environment-specific determination of at least one action option of a movable robot part in accordance with the invention;

FIG. 2 shows an exemplary use of a GPT-based language model in accordance with the invention;

FIG. 3 shows a computer-implemented method in accordance with the invention;

FIG. 4 shows a computer-implemented device in accordance with the invention; and

FIG. 5 shows a system in accordance with the invention.

### DETAILED DESCRIPTION OF THE EXEMPLARY EMBODIMENTS

In the figures, identical or functionally identical elements have been provided with the same reference signs, unless indicated otherwise.

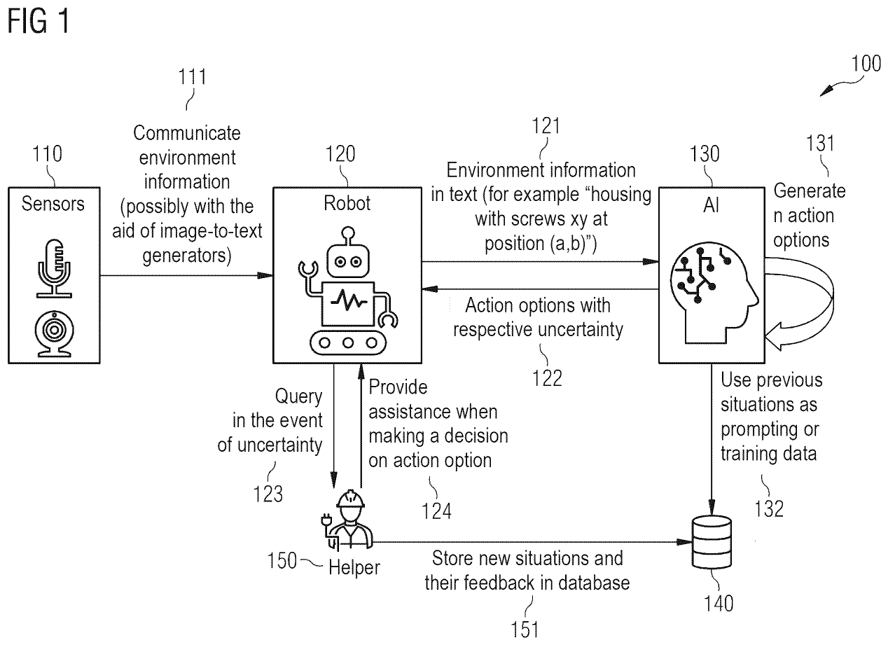

FIG. 1 shows a schematic flowchart 100 of a method for the environment-specific determination of at least one action option of a movable robot part.

The schematic flow begins with the acquisition of information associated with the environment of the movable robot part. This information may be acquired via at least one sensor 110. The sensor 110 may be, for example, a camera (a real-color camera and/or an infra-red (IR) camera), a microphone, a vibration sensor, a distance sensor (light and/or ultrasound-based) or a temperature sensor. Based on the at least one sensor 110, the acquired information may thus comprise image information, and/or sound information. The information thereby acquired may be a single camera image and/or a single sound sequence. The acquired information may comprise information about an object to be manipulated (for example, an object type of and/or pose information concerning the object) contained in the environment.

The at least one sensor 110 may be in unidirectional or bidirectional communication 111 with a robot 120. For the communication 111 of the at least one sensor 110 and the robot 120, the information acquired via the sensor 110 may be converted into a description (for example, a textual description) of the environment thus reproduced (for example, with the aid of image-to-text generators, such as an LLM or a GPT as described herein). The environmental information acquired by the at least one sensor 110 may thereby be described. In this procedure, for example, a recorded camera image may be converted, using known neuromodels, into a text form comprehensible to the language model and precisely describing the recorded image. It may be necessary to train the underlying model in accordance with the task (for example, by transferring the meta-information “A battery from manufacturer ABC and of type XYZ is in the image at the position of the bounding box ((x, y), (x+delta_x, y+delta_y)). It is screwed on its surface with screws at positions (p1, p2, p3, p4), requiring tool CDE” to the model to be trained). Ideally, a camera equipped to acquire an appropriate image is designed such that all relevant surface features are able to be acquired. The text or description thus generated may form the basis for an input (prompt) to a GPT (as described herein).

Information may in this case comprise a multiplicity of camera images and/or a multiplicity of sound sequences.

The information acquired by the (at least one) sensor 110 may be shared with the robot 120 based on the communication. The robot 120 may comprise at least one movable robot part and/or be in communication therewith in order to control it and cause it to move.

The robot 120 may convert the description that has been acquired by the sensor 110 into an explicit environment description 121 and communicate it to an artificial intelligence 130. The explicit environment description 121 may contain a description of the features of the environment that is to be given for a subsequent manipulation operation of an object by (at least the movable robot part of) the robot 120. This may comprise, for example, a statement in the form “Housing with screws xy at position (a,b)”. This means that the description may contain firstly information about what the object to be manipulated is (for example, a housing) and secondly what components the object contains that are to be manipulated by the movable robot part (for example, screws “xy”). The description may furthermore contain information about the position at which the components that are to be manipulated by the movable robot part are located. The explicit environment description may furthermore be enriched with information from a disassembly manual (for example, for the relevant model and/or similar models). The input to be generated in this way may require formatting in a standardized input format (for example, in the “csv” format).

In some cases, the interaction of the textual environment information provided via communication 111 and of the environment description 121 may be understood to be a textual description as described herein.

The artificial intelligence 130 may be provided, for example, as a first neural network. The artificial intelligence 130 may be configured to determine at least one action option 131 based on the description.

The at least one action option 131 may, based on the provided description, describe a movement at least of the movable robot part of the robot 120 that may lead to a manipulation of the object that should be considered to be optimum based on the present situation.

In some cases, the description may be provided to the artificial intelligence 130 N times (as described herein). In such a case, the at least one action option 131 may be provided N times.

The determination of the at least one action option 131 may furthermore comprise determining an uncertainty associated with the at least one action option 131. The uncertainty may be provided as described herein.

In some cases, the artificial intelligence 130 may use previous situations as prompting and/or training data 132.

Prompting may be understood to mean generation, processing and/or optimization of descriptions or prompts that serve as the basis for interaction with artificial intelligence systems or language models. This process may comprise formulating, structuring and adapting text elements that aim to produce a precise, targeted and contextual output or answer from an artificial intelligence (for example, the artificial intelligence 131). In the present case, the prompting may comprise applying an input to the artificial intelligence 130 that leads to the output of at least one action option 131 that should be considered to be optimum.

This means that, based on assignments of description and a determined at least one action option (in the sense of training data) that have already been used in the past, at least one action option 131 may be determined for an application case that is currently present.

The corresponding training data or the information associated with the prompting may be stored in a database 140.

The determined at least one action option 131 (optionally together with the determined associated uncertainty) may be transmitted to the robot 120 (and thus the movable robot part) as a message 122.

Based on the at least one action option 131 transmitted via the message 122, the robot 120 (or the movable robot part) may determine whether the provided at least one action option 131 is defined to an extent sufficient to be performed by the robot 120 or the movable robot part.

If it is determined that the at least one action option 131 is not sufficiently defined, then the robot 120 (or the movable robot part) may initiate a dialog and, for example, send a question 123 to an auxiliary entity 150. The question 123 may be formulated such that it aims specifically to obtain information that allows the at least one action option 131 to be defined sufficiently, so that the at least one action option 131 is able to be performed by the robot 120 (or the movable robot part).

The auxiliary entity 150 may be provided as described herein. It may be provided, for example, as a human operator who may be located in close proximity to the robot 120 (for example in the same building). However, it may also be a human who is able to connect to the robot remotely and thereby interact therewith. The human operator may have access to an input signal (camera, live sound sequence) and, where applicable, additional information (for example, attributes, and/or log files) of the robot 120. In some cases, the auxiliary entity 150 may also be provided as a human operator who may connect remotely to another auxiliary robot in the proximity of the first robot (i.e., the robot 120), where the auxiliary robot may be configured to perform additional work. In some cases, the auxiliary entity 150 may be an artificial intelligence (for example, a second trained neural network) that, for example, has access to a larger database (for example a larger training database) or comprises more background knowledge about objects and materials of the task to be solved (such as online GPT services).

Based on the input of the auxiliary entity 150, guidance 124 may be given to make a decision on an action option.

In some cases, the determination of the at least one action option 131 may be associated with the determination of a (first) uncertainty indicative of an uncertainty with which an acquired object has been assigned to an object type. The determined uncertainty may be associated with an uncertainty with which the object was classified.

The uncertainty may be determined, for example, by the classifier used. In some cases, this may be configured such that it calculates and provides not only the classification result but also an uncertainty (for example, a model output that was trained based on a negative-log-likelihood loss function or derived from the distribution of the activation strength over all possible output classes of the classifier network). The uncertainty thus obtained may then determine the further procedure.

A determined uncertainty (in percent) may add up to a determined certainty (in percent) of 100% (or equivalent to 1). This may particularly mean that a certainty may be derived from a determined uncertainty via the relationship 100% minus the determined uncertainty, and vice versa.

If the first determined certainty exceeds a first threshold value (for example 95%) and the object type has preferably not been classified as “unknown”, the determined at least one action option 131 may be performed by the movable robot part. In such a case, the underlying classification result may be considered to be certain. In some cases, it is possible to use a database of disassembly plans for known objects. Such plans may be provided by a respective manufacturer of the object. In addition or as an alternative, the disassembly plan may have been learnt during previous disassembly processes or may have been taken from other sources (for example, disassembly videos or textual disassembly instructions from a manufacturer of the object, online videos, and/or disassembly instructions that have been published on relevant portals and/or other suitable sources).

If the first determined certainty falls below the first threshold value and exceeds a second threshold value (for example, 75%), a human operator may be asked to confirm that the determined at least one action option is to be performed, which may be followed by performing the at least one action option based on the confirmation. In such a case, the classification result may be considered to be relatively certain. In some cases, it may be the case in this scenario that the object classification result may be assigned to one or more object classes. In such a case, the robot 120 may ask a human operator and/or the auxiliary entity 150 to confirm that the object should be assigned to a specific object class. This confirmation may be received by the human operator and/or the auxiliary entity 150 in verbal form (for example, “You have correctly identified the situation”). Based thereon, the robot 120 (or a movable robot part) may perform the at least one action option in question accordingly. In some cases, the resulting data (for example, the confirmation, assigned to a given situation, by the human operator and/or the auxiliary entity 150) may be stored and, where applicable, used for follow-up training in order to be able to react better in future (similar) situations.

As an alternative, if the determined first certainty is less than the second threshold value, then at least one predefined action option may be provided to a human operator, confirmation may be acquired from the human operator that the provided predefined action option is to be performed, and the predefined action option may be performed based on the acquired confirmation. In some cases, a multiplicity of possible predefined action options may also be suggested to the human operator (for example, auxiliary entity 150). In such a case, the classification result may be considered to be (highly) uncertain, i.e., the probability of the object being able to be correctly assigned to any object class should be considered to be low for all classes, or the classification leads to the result “unknown”. Here, it may also be possible to store the information thereby obtained and to use it in (similar) future cases.

As described above, it may also be possible for the auxiliary entity 150 to verify and confirm possibly hitherto unknown action options as valid. This may be accompanied by storing 151 the new situation in a database (for example the database 140).

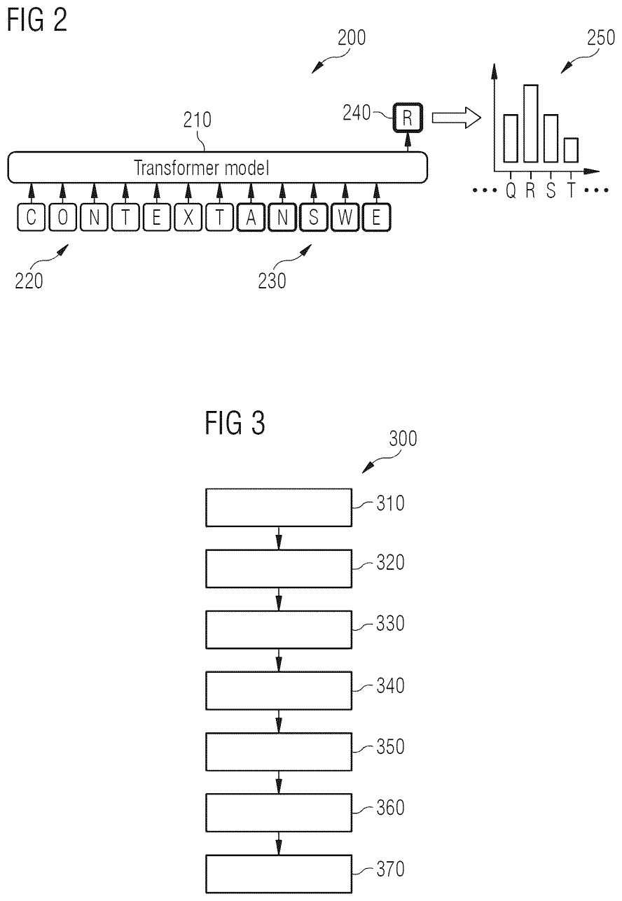

FIG. 2 shows the exemplary use 200 of a GPT-based language model. The use 200 may be based on use of an aleatoric uncertainty resulting from repeated (for example, n times) provision of a textual description to the first neural network.

Here, an input 220 “CONTEXT” may be transferred to a language model 210 (for example, a GPT language model). The input 220 may be transferred to the language model 210 N times. Based thereon, a respective output may be rolled for each of the inputs by the language model 210, so as ultimately to give N outputs. A distribution function may be formed from the outputs thus obtained.

Each of the at least one action options may consist of multiple interference steps, because the language model 210, for example, is able to provide only a distribution about the probabilities for the next token (for example, the next letter), which is converted, for example, from a logits representation to a probability distribution by applying a Softmax function. By transferring the input “CONTEXT” to the model input n times, it is thus possible to obtain m, with m≤n (due to a standardized output format), different action options. This may lead, in the event of the repeated input “CONTEXT” to the language model 210, together with the already received answer 230 (here “ANSWER”), to various further letters 240 (here “R”) being able to be generated. Based thereon, a frequency distribution 250 may be generated via the letters thus obtained, in which the (relative) frequency for different outputs generated by the language model 210 is plotted against the respective, different outputs (for example, Q, R, S, and/or T). This may ultimately contribute to determining a respective different at least one action option.

Based thereon, it may be made possible to derive the underlying aleatoric uncertainty from a relative frequency of the action options obtained from the interference process, for example, based on the identification of how often, measured in percent, the most frequently rolled action option occurs relative to the other possible m−1 options.

If an output of the model is already known (and/or if it is already known what output the model will probably generate), then the distribution of the activation strength over all tokens generated for the output may also be considered directly.

In some cases, it may be the case that the answer from the language model 210 becomes lengthy (for example, more than 5, 10, 15, 20, 25, 30, 50, 100 or more than 150 letters), and there may thus be exponential growth of the possible answers generated by the language model 210. This may be at least partially compensated for by providing a standardized output format.

This may facilitate a comparison between different predicted action options. For example, the at least one action option “Loosen the third screw from the left on the housing” may thus be considered to be semantically identical to the at least one action option “There are four screws on the housing. Seen from the left, the third screw should now be loosened first”.

When using a standardized format, such as “Loosen, screw, position (x,y)”, a syntactic identity may also be achieved via the at least one action option. This may significantly limit the number of possible outputs. Such a procedure may also be configured to eliminate filler words that may be present in the at least one action option (provided in textual form), which may likewise contribute to reducing the space of the possible m action options.

The relative frequency of each action option may be associated with a certainty that this action option may actually be considered to be the correct action option. As already described, the robot 120 (as described with reference to FIG. 1) may perform the action option or, if necessary, in the presence of uncertainty, request further information from an auxiliary entity and/or a human operator.

In some cases, a result of the procedure described with reference to FIG. 2 may, after it has been determined, also be stored as a disassembly plan in the form of a dataset of a database, which may be associated with an object type as new and hitherto unknown.

The method discussed herein may be repeated until the robot 120 receives the message, as an action option and/or from a human operator and/or an auxiliary entity, that the manipulation of the object to be performed was able to be completed successfully.

During this iterative procedure, all determined action options and any decisions resulting therefrom may be stored in a logbook to ensure traceability of all individual steps of the robot. This logbook may, for example, serve as additional information in the form of inputs (or prompting) or new training data for follow-up training.

In some cases, it may thus be established, such as later, whether other action options might have been better in certain situations (for example, in the sense of a feedback function). The follow-up training makes it possible to further improve the meaningfulness of the underlying artificial intelligence (for example, the AI 130 as described with reference to FIG. 1) and make same more robust.

In some cases, a disassembly process may be particularly complex. In such cases, it may be advantageous to divide the disassembly process into partial (disassembly) processes. In some cases, provision may be made for a disassembly process of the object to be divided into a disassembly process of respective partial objects.

In such a complex case, a robot may first examine the environment in question via the at least one sensor (for example, a camera), and pass on the information thereby obtained to an AI (as described herein). The AI may be configured to perform a classification in order to recognize an existing task (for example, a disassembly process). Trained neural networks, such as YOLO and/or CNNs, may be considered for this purpose. The disassembly process to be performed may comprise recognizing the object type, the object manufacturer, and/or the pose of the object. In this case, similar objects may be grouped together in an object class, and a classifier may determine the class into which a particular object falls for each object based on the acquired information associated with an environment of the movable robot part. It may be required here that a specific object falls into a predefined class (for example, one of the classes “battery” or “housing”). In addition, a class for “unknown” may be provided for unknown objects (an assignment to the class “unknown” may be made, for example, if a processed object results in only low activations (i.e., activation values that are smaller than the average activation values associated with objects that have been assigned to classes other than the class “unknown”)). In addition or as an alternative, a class may be provided for “other objects”. In some cases, the neural network that is used may have been trained to classify the classes “unknown” and/or “other objects”.

FIG. 3 shows a computer-implemented method 300 for the environment-specific determination of at least one action option of a movable robot part.

In step 310, information associated with an environment of the movable robot part is acquired.

In step 320, the acquired information is converted into a description of the environment.

In step 330, the description is provided to a first trained neural network.

In step 340, the first trained neural network determines the at least one action option based on the description provided.

In step 350, it is determined whether the provided at least one action option is defined to an extent sufficient to be performed by the movable robot part.

In step 360, a dialog is initiated with an auxiliary entity different from the robot part in order to acquire further context information upon determining that the provided at least one action option is not sufficiently defined.

In step 370, the at least one action option is provided to a controller of the movable robot part.

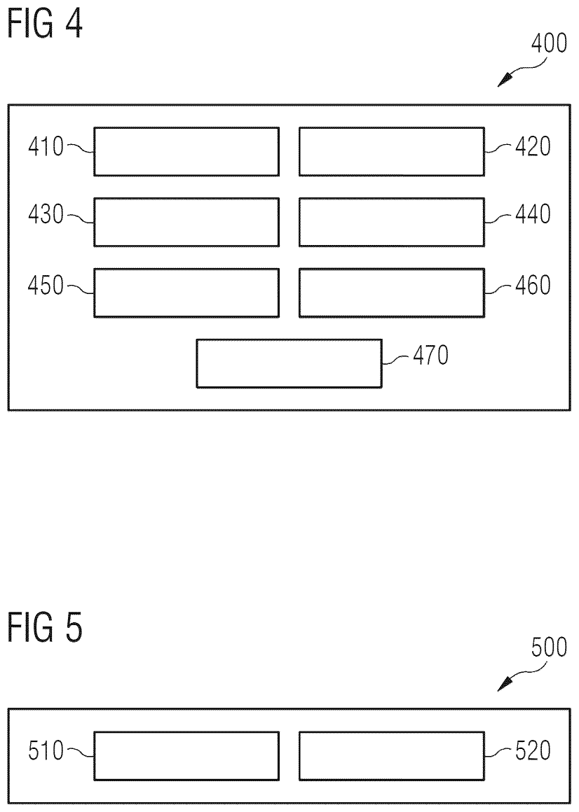

FIG. 4 shows an exemplary computer-implemented device 400 for the environment-specific determination of at least one action option of a movable robot part. The computer-implemented device 400 comprises an acquisition unit 410, a conversion unit 420, a first provision unit 430, a first determination unit 440, a second determination unit 450, an initiation unit 460 and a second provision unit 470.

The acquisition unit 410 is configured to acquire information associated with an environment of the movable robot part.

The conversion unit 420 is configured to convert the acquired information into a description of the environment.

The first provision unit 430 is configured to provide the description to a first trained neural network.

The first determination unit 440 is configured to determine, via the first trained neural network, the at least one action option based on the description provided.

The second determination unit 450 is configured to determine whether the provided at least one action option is defined to an extent sufficient to be performed by the movable robot part.

The initiation unit 460 is configured to initiate a dialog with an auxiliary entity different from the robot part to acquire further context information if it has been determined that the provided at least one action option is not sufficiently defined.

The second provision unit 470 is configured to provide the at least one action option to a controller of the movable robot part.

FIG. 5 shows a system 500 for the environment-specific determination of at least one action option of a movable robot part.

The system 500 comprises the computer-implemented device 510 as described herein. In some cases, the computer-implemented device 510 may be provided in the same way as the computer-implemented device 400.

The system 500 comprises the computer program product 520 as described herein.

Although the present invention has been described on the basis of exemplary embodiments, it is able to be modified in diverse ways.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for environment-specific determination of at least one action option of a movable robot part, the method comprising:
acquiring information associated with an environment of the at least one movable robot part;
converting the acquired information into a description of the environment;
providing the description to a first trained neural network;
determining, by the first trained neural network the at least one action option based on the provided description;
determining whether the provided at least one action option is defined to an extent sufficient to be performed by the at least one movable robot part;
initiating a dialog with an auxiliary entity different from the at least one robot part to acquire further context information upon determining the provided at least one action option is not sufficiently defined; and
providing the at least one action option to a controller of the movable robot part.

2. The computer-implemented method as claimed in claim 1, wherein the auxiliary entity comprises at least one of (i) a human operator of the movable robot part, (ii) a human operator who can connect remotely to the at least one movable robot part, (iii) a human operator who can connect remotely to an auxiliary robot in a vicinity of the at least one movable robot part, and (iv) a second trained neural network which has been trained on a larger training database than the first trained neural network.

3. The computer-implemented method as claimed in claim 1, wherein the at least one action option of the movable at lest one robot part is associated with a disassembly plan of at least one of an electrical device and a battery.

4. The computer-implemented method as claimed in claim 2, wherein the at least one action option of the movable at lest one robot part is associated with a disassembly plan of at least one of an electrical device and a battery.

5. The computer-implemented method as claimed in claim 3, wherein providing the description comprises taking into account a provided disassembly plan for at least one of the electrical device and the battery.

6. The computer-implemented method as claimed in claim 3, wherein the computer-implemented method is implemented for each step of a disassembly step associated with the disassembly plan.

7. The computer-implemented method as claimed in claim 5, wherein the computer-implemented method is implemented for each step of a disassembly step associated with the disassembly plan.

8. The computer-implemented method as claimed in claim 1, wherein at least one of the first trained neural network and the second trained neural network comprises a large language model (LLM).

9. The computer-implemented method as claimed in claim 8, wherein the large language model (LLM) comprises a generative pre-trained transformer (GPT).

10. The computer-implemented method as claimed in claim 1, wherein acquiring the information further comprises at least one of:
(i) acquiring an object type of an object that is to be manipulated by the at least one movable robot part;
(ii) acquiring a manufacturer of the object; and
(iii) acquiring a pose of the object in the environment.

11. The computer-implemented method as claimed in claim 10, wherein the computer-implemented method, when acquiring the information comprises acquiring an object type of an object, furthermore comprises determining a first uncertainty indicative of an uncertainty with which an acquired object has been assigned to an object type; and
evaluating the determined uncertainty;
wherein one of:
(i) if the determined uncertainty exceeds a first threshold value:
the at least one movable robot part implements the determined at least one action option;
(ii) if the determined uncertainty falls below the first threshold value and exceeds a second threshold value:
a human operator is asked to confirm that the determined at least one action option is to be implemented,
the at least one action option is implemented based on a confirmation; and
(iii) if the determined uncertainty is less than the second threshold value:
at least one predefined action option is provided to the human operator,
confirmation from the human operator that the provided predefined action option is to be implemented is acquired, and
the predefined action option is implemented based on the acquired confirmation.

12. The computer-implemented method as claimed in claim 1, wherein determining the at least one action option furthermore comprises determining an uncertainty associated with determining the at least one action option.

13. The computer-implemented method as claimed in claim 1, wherein the provision of the description and the determination of the at least one action option is repeated N times, with N≥1; and
providing the at least one action option based on the N-times repetition of the provision of the description and determination of the at least one action option.

14. The computer-implemented method as claimed in claim 13, wherein the provision of the at least one action option furthermore comprises:
determining a frequency distribution of the N determined action options;
determining an action option of the N determined action options which has been determined with a maximum frequency; and
providing the determined at least one action option.

15. A computer program product comprising instructions which, when executed by a computer, cause the computer to perform the method as claimed in claim 1.

16. A computer-implemented device for environment-specific determination of at least one action option of a movable robot part, the device comprising:
an acquisition unit for acquiring information associated with an environment of the movable robot part;
a conversion unit for converting the acquired information into a description of the environment;
a first provision unit for providing the description to a first trained neural network;
a first determination unit for determining, via the first trained neural network, the at least one action option based on the description provided;
a second determination unit for determining whether the provided at least one action option is defined to an extent sufficient to be implemented by the movable robot part;
an initiation unit for initiating a dialog with an auxiliary entity different from the robot part to acquire further context information upon determining the provided at least one action option is not sufficiently defined; and
a second provision unit for providing the at least one action option to a controller of the movable robot part.

17. The computer-implemented device as claimed in claim 16, further comprising at least one of:
a first execution unit for performing a computer-implemented method; and
a second execution unit for executing a computer program product.

18. A system for environment-specific determination of at least one action option of a movable robot part, the system comprising:
the computer-implemented device as claimed in either of claim 16; and
a computer program product.
